(19) United States
(12) Patent Application Publication
(10) Pub. No.: US 2007/0232265 A1
(43) Pub. Date: Oct. 4, 2007

(54) Method of security management for wireless mobile device and apparatus for security management using the method

(75) Inventors: Tae Joon Park, Gunpo-si (KR); Tae-Chul Jung, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/507,586

(22) Filed: Aug. 22, 2006

(30) Foreign Application Priority Data
Apr. 3, 2006 (KR) 10-2006-0030273

(51) Int. Cl. H04M 3/16

(52) U.S. Cl. 455/410

(57) ABSTRACT

A method of security management of a wireless mobile device interoperating with a network switching center (NSC) is provided, and an apparatus using the method. The method includes respectively managing a traffic map by each service-level, wherein wireless mobile devices frequently communicating with other wireless mobile devices are grouped and stored as a group, among wireless mobile devices on a network, detecting a wireless mobile device determined to be associated with at least any one of a security attack and a malicious code by analyzing data traffic received from a network switching center, and isolating up to all wireless mobile devices within the group in which the detected wireless mobile device is included, from the network by referring to the traffic map.

### CROSS-REFERENCE TO RELATED APPLICATION

This application claims the benefit under 35 U.S.C. §119(a) of Korean Patent Application No. 10-2006-0030273, filed in the Korean Intellectual Property Office on Apr. 3, 2006, the entire disclosure of which is incorporated herein by reference.

### BACKGROUND OF THE INVENTION

1. Field of the Invention

The present invention relates to a wireless mobile device. More particularly, the present invention relates to a method of security management of a wireless mobile device capable of reducing damage caused by a security attack and a malicious code in the wireless mobile device, and an apparatus using the method.

2. Description of Related Art

As mobile wireless devices such as mobile phones and personal digital assistants (PDAs) have become more popular, the mobile wireless device has become a basic necessity in modern society. Many people communicate with each other and exchange information using these mobile wireless devices. For example, businessmen often exchange critical business information using voice or data communication through mobile wireless devices.

As the mobile wireless device has been developed and hardware specifications of the mobile wireless device have been upgraded, an operating system (OS) such as Windows or Linux has been installed on the mobile wireless device, and various application software has been provided based on the OS. Also, as functions of the mobile wireless device have been varied, a variety of application modules including hardware modules such as Digital Multimedia Broadcasting (DMB) modules, and Bluetooth modules for wireless personal area network communication, and software modules such as Multimedia Messaging System (MMS) modules and phone-book modules for managing registered telephone numbers, have also been included in mobile wireless devices.

As the hardware of the mobile wireless device has become more sophisticated, an application which is provided in the mobile wireless device has been varied and has become complicated, allowing malignant codes such as viruses or worms to cause irreparable damage to the mobile wireless device, as well as to computers.

Namely, because the mobile wireless device is operated based on an OS similar to a general computer, and a device driver to operate an installed hardware module is installed, the mobile wireless device may become infected by viruses or worms, and malfunctions or deletion of data may be caused.

Further, since mobile wireless devices are connected to each other via a wireless network, malignant codes such as viruses or worms may rapidly proliferate to other devices.

In a conventional method of security management of a wireless mobile device, signatures of the viruses and malicious codes, reported within a database in a wireless mobile device, are stored and checks are made to determine whether there is an identical signature by respectively comparing the stored signatures with input data.

Accordingly, the database storing the signatures is required to be updated, however, the conventional method of security management of the wireless mobile device has a problem caused by a time lag between a proliferation point in time of the virus and a development/distribution point in time of an updated database. Namely, an unacceptable amount of time is required to develop/distribute a solution for the virus or malicious code from a point in time that a new virus or malicious code occurs to a point in time that the solution for the new virus or malicious code is developed/distributed, since determination/counteraction for the new virus or malicious code is performed by an antivirus providing company. Also, in the conventional method of security management of the wireless mobile device, it is a significant burden for the wireless mobile device to maintain and update a huge database and keep checking a huge amount of input data. Also, electric power consumption increases, which creates a problem when the wireless mobile device is a portable device. Furthermore, in the conventional method of security management of the wireless mobile device, when a user does not update a database, the user becomes vulnerable to damage from the new virus or malicious code.

Accordingly, in order to provide immediate and effective protection from a virus or malicious code, a need exists for a method of security management of a wireless mobile device and an apparatus using the method.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method of security management of a wireless mobile device capable of immediately and effectively protecting the wireless mobile device from a security attack and/or a malicious code by appropriately interoperating with a network switching center (NSC), and an apparatus using the method.

Embodiments of the present invention also provide a method of security management of a wireless mobile device capable of immediately preventing a security attack and/or a malicious code from proliferating by initially isolating up to all wireless mobile devices from a network by using a traffic map in which the wireless mobile devices frequently communicating with other wireless mobile devices are grouped and stored as a same group, and an apparatus using the method.

Embodiments of the present invention also provide a method of security management of a wireless mobile device capable of effectively managing security of the wireless mobile device by minimizing a time lag between a proliferation point in time and a counteraction point in time of a virus or malicious code, and an apparatus using the method.

Embodiments of the present invention also provide a method of security management of a wireless mobile device capable of effectively detecting and automatically repairing a wireless mobile device infected by a security attack and/or a malicious code, and an apparatus using the method.

According to an aspect of embodiments of the present invention, a method of security management of a wireless mobile device is provided, comprising managing a traffic map by each service-level, the traffic map in which the wireless mobile devices frequently communicating with other wireless mobile devices are grouped and stored as a same group, among wireless mobile devices on a network, detecting a wireless mobile device determined to be associated with at least any one of a security attack and/or a malicious code by analyzing data traffic received from a NSC, and isolating up to all wireless mobile devices within the group in which the detected wireless mobile devices are included, from the network by referring to the traffic map.

In this case, the method of security management of a wireless mobile device further comprises detecting an infected wireless mobile device by at least any one of the security attack and the malicious code by checking the isolated mobile devices, and recovering the infected wireless mobile devices.

In this case, the method of security management of a wireless mobile device further comprises receiving a report for a wireless mobile device determined to be associated with at least any one of the detected security attack and the malicious code from the wireless mobile device which detected the security attack and the malicious code by analyzing peripheral data traffic, wherein the step of isolating devices from the network is accomplished by referring to the traffic map to isolate up to all wireless mobile devices within a group corresponding to the received report.

According to another aspect of embodiments of the present invention, an apparatus of security management of a wireless mobile device is provided, comprising a detection database for storing data used for detecting a security attack and/or a malicious code, a detection unit for checking input data traffic and detecting a wireless mobile device determined to be associated with at least any one of the security attack and the malicious code by using the detection database, a traffic map database for grouping and storing wireless mobile devices that frequently communicate with other wireless mobile devices as a same group, among wireless mobile devices on a network, and an isolation unit for isolating up to all wireless mobile devices within the group in which the detected wireless mobile devices are included, from the network by referring to the traffic map.

According to another aspect of embodiments of the present invention, an apparatus of security management of a wireless mobile device is provided, comprising a detection database for storing data used for detecting a security attack and/or a malicious code, a detection unit for checking data traffic received from peripheral wireless mobile devices and detecting a wireless mobile device which is determined to be associated with at least any one of the security attack and the malicious code included in the data traffic by using the detection database, a check/recovery unit for checking whether the wireless mobile device is infected or not and performing a recovery operation when infected, and a remote control unit for communicating with an NSC to control an operation of the check/recovery unit.

In this case, the detection unit may analyze the data traffic received from any one of wireless mobile devices that are geographically proximate and/or service-level connected.

In this case, the detection database may store a normal communication pattern, and the detection unit may determine whether the security attack or the malicious code is included, when data that is not identical or substantially identical to the normal communication pattern stored in the detection database is included in the data traffic.

In this case, the detection database may store signatures of the security attack and/or the malicious code, and the detection unit determines that the security attack and/or the malicious code is included, when data corresponding to the signature stored in the detection database is included in the data traffic.

### BRIEF DESCRIPTION OF THE DRAWINGS

The above and other objects, features, and advantages of certain exemplary embodiments of present invention will become more apparent from the following detailed description, taken in conjunction with the accompanying drawings, in which:

FIG. 1 is a diagram illustrating network connections for describing a method of security management of a wireless mobile device according to an exemplary embodiment of the present invention;

FIG. 2 is a flowchart illustrating operations in a method of security management of a wireless mobile device according to an exemplary embodiment of the present invention;

FIG. 3 is a block diagram illustrating a security management apparatus of a wireless mobile device within a network switching center according to an exemplary embodiment of the present invention; and

FIG. 4 is a block diagram illustrating a security management apparatus of a wireless mobile device according to an exemplary embodiment of the present invention.

Throughout the drawings, like reference numerals will be understood to refer to like parts, components and structures.

### DETAILED DESCRIPTION OF EXEMPLARY EMBODIMENTS

The matters defined in the description such as detailed constructions and elements, are provided to assist in a comprehensive understanding of the embodiments of the present invention. Accordingly, those of ordinary skill in the art will recognize that various changes and modifications of the exemplary embodiments described herein can be made without departing from the scope and spirit of the present invention. Also, descriptions of well-known functions and constructions are omitted for clarity and conciseness.

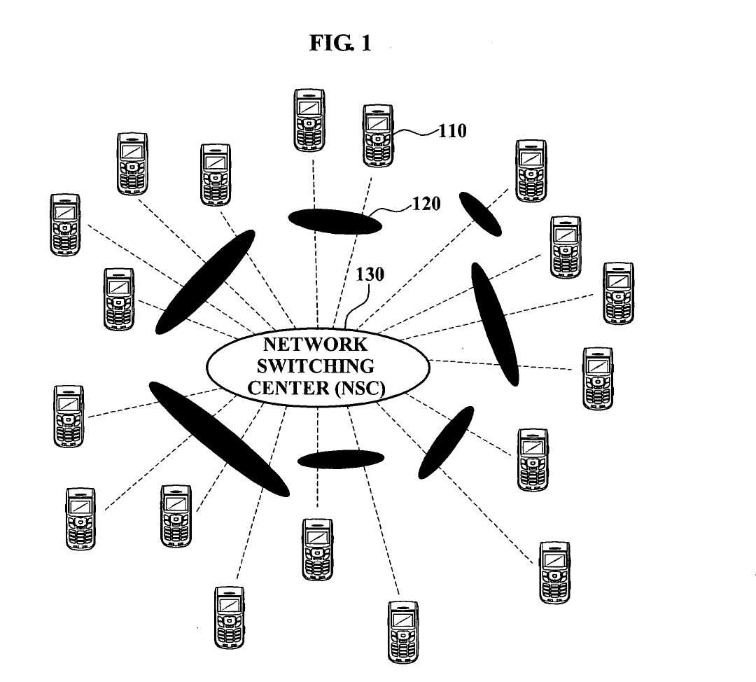

FIG. 1 is a diagram illustrating network connections for describing a method of security management of a wireless mobile device according to an exemplary embodiment of the present invention.

Referring to FIG. 1, the wireless mobile device 110 is connected to a network switching center (NSC) 130 through a base station 120. Each of the wireless mobile devices 110 communicates with a corresponding base station 120 through a wireless link, and the base station 120 transfers communication data to the NSC 130. The wireless mobile devices 110 may include cellular phones, smart phones, personal digital assistants (PDAs) and the like.

Most data is switched to either other wireless mobile devices or an external network through the NSC 130. Accordingly, the NSC 130 may greatly increase effectiveness of security by initially detecting a security attack and/or a malicious code, and initially isolating wireless mobile devices likely to be infected by the security attack and/or the malicious code.

In this case, the malicious code may include a virus, worm, spam, and the like.

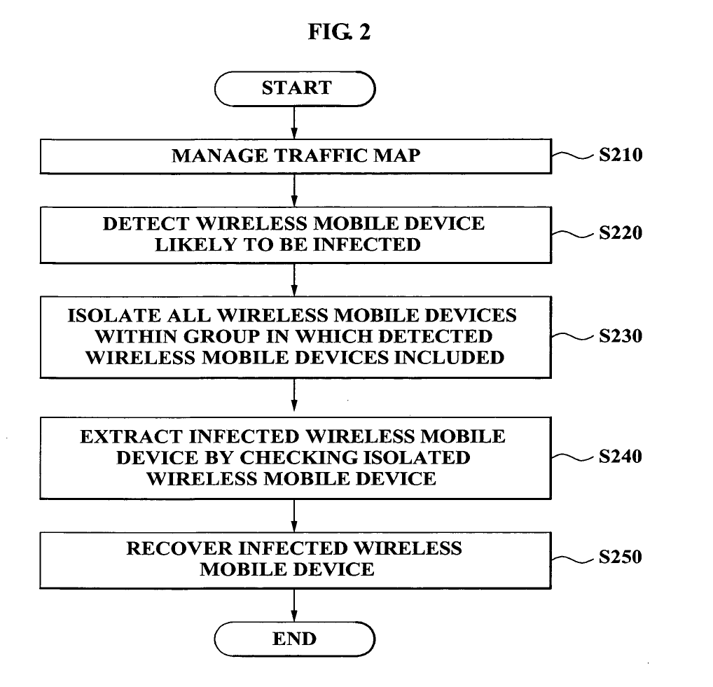

FIG. 2 is a flowchart illustrating operations in a method of security management of a wireless mobile device according to an exemplary embodiment of the present invention.

Referring to FIG. 2, in operation S210, a method of security management of a wireless mobile device according to an exemplary embodiment of the present invention manages a traffic map by each service-level, wherein the traffic map groups and stores the wireless mobile devices frequently communicating with other wireless mobile devices as a same group, among wireless mobile devices on a network;

In this case, the traffic map may be stored in the NSC 130 shown in FIG. 1. The method of security management of the wireless mobile device according to the exemplary embodiment of the present invention may effectively determine a wireless mobile device likely to be an infection route when a security attack and/or a malicious code are proliferating by grouping the wireless mobile devices frequently communicating with other wireless mobile devices among the wireless mobile devices in a network.

In this case, with respect to the traffic map, the infection route may be more accurately predicted by respectively managing the traffic map at each service-level since frequently communicating wireless mobile devices may be different according to each service-level, e.g. frequently communicating wireless mobile devices may be different between voice communication and data communication. The most highly probable infection route is determined by respectively managing a traffic map for the voice communication and the data communication.

Namely, a traffic map determines a predetermined number of wireless mobile devices having a greater amount of data transmitting/receiving with a specific wireless mobile device, and the determined wireless mobile device may be grouped and managed.

In operation S220, a wireless mobile device determined to be associated with at least any one of a security attack and a malicious code is detected by analyzing data traffic received from the NSC 130 shown in FIG. 1.

Namely, a wireless mobile device likely to be infected is detected. In this case, in the method of security management of the wireless mobile device, a wireless mobile device likely to be infected is detected by analyzing data traffic received from the NSC 130 shown in FIG. 1, so that all data in a network may be checked.

In operation S220, a normal communication pattern is stored in a database and data which is not identical or substantially identical to the normal communication pattern stored in the database, among the data traffic, is determined as either the security attack or the malicious code according to an exemplary embodiment of the present invention.

In operation S220, signatures of the security attack and the malicious code are stored in the database, and any data traffic pattern corresponding to the signature stored in the database may be determined as either the security attack or the malicious code, among the data traffic, according to the exemplary embodiment of the present invention.

In operation S230, a method of security management of a wireless mobile device according to an exemplary embodiment of the present invention isolates up to all wireless mobile devices within a group in which the detected wireless mobile devices are included, from the network by referring to the traffic map.

Namely, the method of security management of the wireless mobile device according to an exemplary embodiment of the present invention may effectively prevent an infection from proliferating by initially detecting a security attack and/or a malicious code and initially isolating wireless mobile devices likely to be infected by the security attack and/or the malicious code.

In operation S240, a method of security management of a wireless mobile device according to an exemplary embodiment of the present invention detects wireless mobile devices infected by at least any one of the security attack and the malicious code by checking the isolated mobile devices.

Namely, after isolating up to all wireless mobile devices likely to be infected from the network, a recovery for an infected wireless mobile device may be performed by checking whether the isolated wireless mobile devices are infected or not, and identifying the infected wireless mobile device.

In this case, the step of checking whether the isolated wireless mobile devices are infected or not is performed in the wireless mobile device that received a check request from the NSC 130 shown in FIG. 1.

As an example, the step of checking whether the isolated wireless mobile devices are infected or not may be performed by a checksum calculation for an entire program memory, but is not limited thereto.

In operation S250, a method of security management a wireless mobile device according to an exemplary embodiment of the present invention then recovers infected wireless mobile devices.

In this case, the recovery of the infected wireless mobile devices may be performed in a wireless mobile device receiving a recovery request among wireless mobile devices which is determined to be infected in operation S240.

In this case, the recovery of the infected wireless mobile device may be performed by either partially patching or entirely resetting programs of the infected wireless mobile device to default settings, but is not limited thereto.

According to an exemplary embodiment of the present invention, the method of security management of the wireless mobile device shown in FIG. 2 further comprises an operation of receiving a report for a wireless mobile device determined to be associated with at least any one of the detected security attack and the malicious code from the wireless mobile device which detected the security attack and the malicious code by analyzing peripheral data traffic.

Namely, the method of security management of the wireless mobile device according to the exemplary embodiment of the present invention reports to isolate, from the network, wireless mobile devices likely to be infected when data likely to be the security attack and/or the malicious code is detected while checking transmitted/received data traffic from wireless mobile devices that are geographically proximate to each other or service-level connected, including when the security attack or the malicious code is detected in the NSC. In this case, operation S230 may isolate, from the network, up to all the wireless mobile devices within the group in which the detected wireless mobile devices are included, by referring to the traffic map.

Each operation in FIG. 2 may be sequentially or simultaneously performed, in either ascending or descending order.

The method of security management of the wireless mobile device according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so forth, including carrier wave transmitting signals specifying the program instructions, data structures, and so forth. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

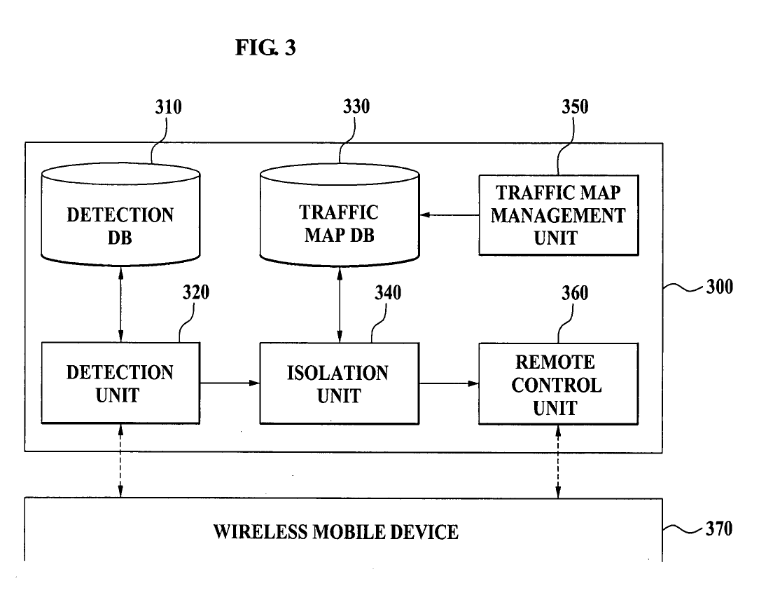

FIG. 3 is a block diagram illustrating a security management apparatus of a wireless mobile device within an NSC according to an exemplary embodiment of the present invention.

Referring to FIG. 3, a security management apparatus 300 of a wireless mobile device within the NSC comprises a detection database (DB) 310, a detection unit 320, a traffic map database (DB) 330, an isolation unit 340, a traffic map management unit 350, and a remote control unit 360.

The detection database 310 stores data used for detecting a security attack and/or a malicious code.

The detection unit 320 checks input data traffic and detects a wireless mobile device determined to be associated with at least any one of a security attack and a malicious code included the data traffic by using the detection database 310.

Namely, the detection unit 320 detects the wireless mobile device determined to be infected by the security attack and/or a malicious code according to a predetermined determination reference by using the detection database 310.

As an example, the detection database 310 stores a normal communication pattern, and the detection unit 320 determines that the security attack or the malicious code is included when data which varies from the normal communication pattern stored in the detection database 310 is included in the data traffic. Specifically, the detection database 310 stores a signature of the security attack and/or the malicious code, and the detection unit 320 may determine that the security attack or the malicious code is included in the data traffic, when data corresponding to the signatures stored in the detection database 310 is included the data traffic.

The traffic map database 330 groups and stores wireless mobile devices that frequently communicate with other mobile devices as a same group by each service, among wireless mobile devices on a network.

The isolation unit 340 isolates up to all wireless mobile devices within the group in which the detected wireless mobile devices are included, from the network by referring to the traffic map database 330.

Namely, the isolation unit 340 isolates, from the network, a wireless mobile device likely to be infected by the security attack and/or the malicious code, and a group of wireless mobile devices highly likely to be infected by the isolated wireless mobile device, to prevent the security attack and/or the malicious code from proliferating.

According to an exemplary embodiment, the detection unit 320 may receive a report regarding a wireless mobile device determined to be associated with at least any one of the security attack and the malicious code from a wireless mobile device 370, i.e. the security attack and the malicious code are detected in the detection unit 320 within the wireless mobile device 370, and the detection unit 320 may receive the report regarding the wireless mobile device as likely to be infected. In this case, the detection unit 320 transmits information of the reported wireless mobile device to the isolation unit 340, and the isolation unit 340, by referring to the traffic map database 330, may isolate from the network up to all wireless mobile devices within the group in which the reported wireless mobile device is included.

As described above, the detection unit within the NSC checks the data traffic of the entire network, and the detection unit within the wireless mobile device 370 may check the traffic among wireless mobile devices geographically proximate or service-level connected, such as, Bluetooth communications, which are difficult to be checked in the NSC.

The traffic map management unit 350 manages the traffic map database by each service, i.e. the traffic map management unit 350 may generate or update the traffic map database by each service.

The remote control unit 360 performs checking and recovery operations by communicating with the wireless mobile device 370 isolated from the network. In this case, the remote control unit 360 may communicate with a remote control unit within the wireless mobile device 370.

The remote control unit 360 may transmit a check request to the wireless mobile device 370, receive a check result and transmit a determination result by determining whether or not the recovery is to be performed, according to the check result. In this case, the remote control unit 360 may transmit a check algorithm including the check request to the wireless mobile device 370.

The remote control unit 360 may control the recovery by partially patching or entirely resetting programs of the wireless mobile device to default settings.

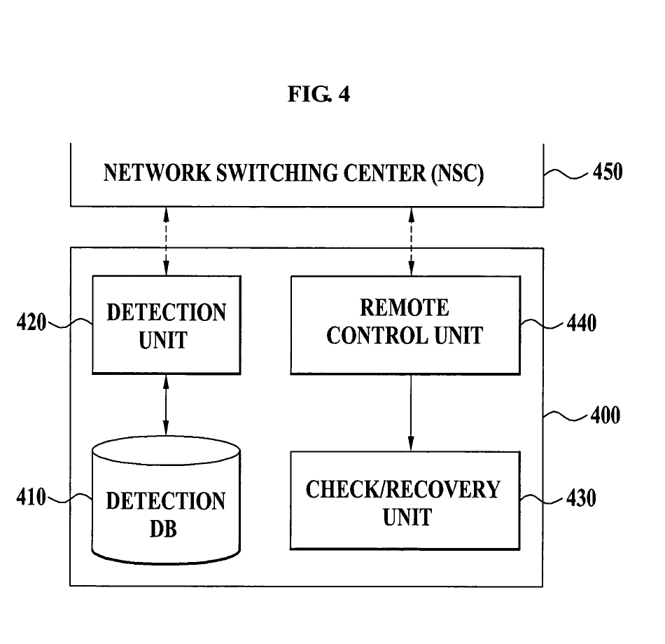

FIG. 4 is a block diagram illustrating a security management apparatus of a wireless mobile device according to an exemplary embodiment of the present invention.

Referring to FIG. 4, the security management apparatus 400 of a wireless mobile device according to an exemplary embodiment of the present invention comprises a detection database (DB) 410, a detection unit 420, a check/recovery unit 430, and a remote control unit 440.

The detection database 410 stores data used for detecting a security attack and/or a malicious code.

The detection unit 420 analyzes data traffic received from adjacent wireless mobile devices, and detects and reports a wireless mobile device determined to be associated with at least any one of a security attack and a malicious code included the data traffic by using the detection database 410 of an NSC 450.

In this case, the adjacent wireless mobile devices may be wireless mobile devices geographically proximate to each other or service-level connected. Moreover, the step of detecting the security attack and the malicious code using the detection database 410 and the detection unit 420 may be effectively utilized for LAN traffic which is difficult to be checked in the NSC 450, such as Bluetooth communications.

As an example, the detection database 410 stores a normal communication pattern, and the detection unit 420 determines that the security attack or the malicious code is included, when data, which varies from the normal communication pattern stored in the detection database 410, is included in the data traffic. Specifically, the detection database 410 stores signatures of the security attack and/or the malicious code, and the detection unit 420 may determine that the security attack or the malicious code is included in the data traffic, when data corresponding to the signatures stored in the detection database 410 is included the data traffic.

The check/recovery unit 430 checks whether the wireless mobile device is infected or not, and performs the recovery when infected.

The check/recovery unit 430 may operate according to a three-way handshake protocol checking whether the wireless mobile device is infected or not by receiving a check request from the NSC 450, transferring a check result to the NSC 450, and performing the recovery by receiving information on whether or not the recovery is to be performed.

In this case, the check/recovery unit 430 may perform the recovery by either partially patching or entirely resetting programs of the infected wireless mobile device to default settings, but is not limited thereto.

According to an exemplary embodiment of the present invention, the check/recovery unit 430 may be mounted in a tamper-resistant module.

According to another exemplary embodiment of the present invention, the check/recovery unit 430 may be installed inside the OS, a central processing unit (CPU) or dedicated hardware.

The remote control unit 440 may communicate with the NSC 450 to control an operation of the check/recovery unit 430.

In this case, the remote control unit 440 may communicate with the remote control unit 360 within the NSC in FIG. 3.

The exemplary methods of security management of a wireless mobile device of embodiments of the present invention and the apparatus using the methods may immediately and effectively protect wireless mobile devices from a security attack and/or a malicious code by appropriately interoperating with a NSC.

Also, embodiments of the present invention may immediately prevent a security attack and/or a malicious code from proliferating by initially isolating up to all wireless mobile devices from a network by using a traffic map in which the wireless mobile devices frequently communicating with other wireless mobile devices are grouped and stored as a same group.

Also, embodiments of the present invention may effectively manage security of a wireless mobile device by minimizing a time lag between a proliferation point in time and a counteraction point in time of a virus or a malicious code.

Also, embodiments of the present invention may effectively detect and automatically recover a wireless mobile device infected by a security attack and/or a malicious code.

Although a number of exemplary embodiments of the present invention have been shown and described, the present invention is not limited to the described exemplary embodiments. Instead, it can be appreciated by those skilled in the art that changes may be made to these exemplary embodiments without departing from the principles and spirit of the present invention, the scope of which is defined by the appended claims and their equivalents.

What is claimed is:

1. A method of security management of a wireless mobile device, the method comprising:
respectively managing a traffic map by each service-level, wherein wireless mobile devices frequently communicating with other wireless mobile devices are grouped and stored as a group, among wireless mobile devices on a network;
detecting a wireless mobile device determined to be associated with at least one of a security attack and a malicious code by analyzing data traffic received from a network switching center (NSC); and
isolating up to all wireless mobile devices within the group in which the detected wireless mobile device is included, from the network by referring to the traffic map.

2. The method of claim 1, further comprising:
detecting a wireless mobile device infected by at least one of the security attack and the malicious code by checking the isolated mobile devices; and
recovering the infected wireless mobile device.

3. The method of claim 2, wherein the step of detecting the infected wireless mobile device extracts the infected wireless mobile device by checking whether an infection occurred in the wireless mobile device that received a check request from the NSC among the isolated mobile devices, and the step of recovering the detected wireless mobile device performs the recovery in the wireless mobile device that received a recovery request from the NSC.

4. The method of claim 2, wherein the step of recovering the infected wireless mobile device performs the recovery by partially patching or entirely resetting programs of the infected wireless mobile device to default settings.

5. The method of claim 1, further comprising:
receiving a report for a wireless mobile device, determined to be associated with at least one of the detected security attack and the malicious code, from the wireless mobile device which detected the security attack and the malicious code by analyzing peripheral data traffic,
wherein the step of isolating the device from the network is accomplished by referring to the traffic map to isolate up to all wireless mobile devices within a group corresponding to the received report.

6. The method of claim 1, wherein the step of detecting the wireless mobile device, determined to be associated with at least one of the security attack and the malicious code, stores a normal communication pattern in a database and determines that a communication which is not substantially identical to the normal communication pattern stored in the database, among the data traffic, comprises at least one of the security attack and the malicious code.

7. The method of claim 1, wherein the step of detecting the wireless mobile device, determined to be associated with at least one of the security attack or the malicious code, stores signatures of the security attack and the malicious code, and determines that data traffic corresponding to the signatures stored in the database, among the data traffic, comprises at least one of the security attack and the malicious code.

8. A computer-readable program storage medium storing a program for implementing a method of security management of a wireless mobile device, comprising:
a first set of instructions for respectively managing a traffic map by each service-level, wherein wireless mobile devices frequently communicating with other wireless mobile devices are grouped and stored as a group, among wireless mobile devices on a network;
a second set of instructions for detecting a wireless mobile device determined to be associated with at least one of a security attack and a malicious code by analyzing data traffic received from a network switching center (NSC); and
a third set of instructions for isolating up to all wireless mobile devices within the group in which the detected wireless mobile device is included, from the network by referring to the traffic map.

9. An apparatus for security management of a wireless mobile device within a network switching center (NSC), the device comprising:
a detection database for storing data used for detecting at least one of a security attack and a malicious code;
a detection unit for checking input data traffic and detecting a wireless mobile device, determined to be associated with at least one of the security attack and the malicious code, by using the detection database;
a traffic map database for grouping and storing wireless mobile devices that frequently communicate with other wireless mobile devices as a group by each service-level, among wireless mobile devices on a network; and
an isolation unit for isolating up to all wireless mobile devices within the group in which the detected wireless mobile device is included, from the network by referring to the traffic map database.

10. The apparatus of claim 9, further comprising:
a traffic map management unit for managing the traffic map database by each service-level; and
a remote control unit for communicating with the isolated wireless mobile devices from the network to control the isolated wireless mobile devices being checked and recovered.

11. The apparatus of claim 10, wherein the remote control unit is configured to transfer a check request to the isolated wireless mobile devices that are isolated from the network, receive a checked result and determine whether recovery is required according to the checked result, to transfer the determined result.

12. The apparatus of claim 11, wherein the remote control unit is configured to control the recovery by partially patching or entirely resetting programs of the infected mobile device to default settings.

13. The apparatus of claim 9, wherein the isolation unit is configured to isolate, from the network, up to all wireless mobile devices within the group where the wireless mobile devices correspond to a report regarding a wireless mobile device, determined to be associated with at least one of the detected security attack and the malicious code, and the report is received from the wireless mobile device detecting at least one of the security attack and the malicious code.

14. The apparatus of claim 9, wherein the detection database is configured to store a normal communication pattern, and
the detection unit is configured to determine that the security attack or the malicious code is included, when data that is not substantially identical to the normal communication pattern stored in the detection database is included in the data traffic.

15. The apparatus of claim 9, wherein the detection database is configured to store signatures of the security attack and the malicious code, and the detection unit is configured to determine that the security attack or the malicious code is included when data corresponding to the signature stored in the detection database is included in the data traffic.

16. An apparatus for security management of a wireless mobile device, the device, comprising:
a detection database for storing data used for detecting a security attack and a malicious code;
a detection unit for checking data traffic received from peripheral wireless mobile devices and detecting a wireless mobile device, which is determined to be associated with at least one of the security attack and the malicious code, included in the data traffic by using the detection database;
a check/recovery unit for checking whether the wireless mobile device is infected or not and performing a recovery operation when infected; and
a remote control unit for communicating with a network switching center (NSC) to control an operation of the check/recovery unit.

17. The apparatus of claim 16, wherein the detection unit is configured to analyze the data traffic received from at least one of wireless mobile devices geographically proximate to each other, or wireless mobile devices that are service-level connected.

18. The apparatus of claim 16, wherein the check/recovery unit is configured to operate according to a three-way handshake protocol for checking whether the wireless mobile device is infected or not when receiving a check request from the NSC, transferring a check result to the NSC, and performing the recovering by receiving, from the NSC, an instruction on whether to perform the recovery or not.

19. The apparatus of claim 16, wherein the check/recovery unit is configured to perform the recovery by partially patching or entirely resetting programs of the wireless mobile device to default settings.

20. The apparatus of claim 16, wherein the check/recovery unit is mounted in a tamper-resistant module.

21. The apparatus of claim 16, wherein the detection database is configured to store a normal communication pattern, and the detection unit is configured to determine that the security attack or the malicious code is included, when data that is not substantially identical to the normal communication pattern stored in the detection database is included in the data traffic.

22. The apparatus of claim 16, wherein the detection database is configured to store signatures of the security attack and the malicious code, and the detection unit is configured to determine that the security attack or the malicious code is included, when data corresponding to the signature stored in the detection database is included in the data traffic.
